(19) United States
(12) Patent Application Publication
(10) Pub. No.: US 2007/0056339 A1
(43) Pub. Date: Mar. 15, 2007

(54) Combination lock

(76) Inventors: Christopher Irgens, Elm Grove, WI (US); Vince Leslie, Greendale, WI (US); Rebecca Manthe, Chicago, IL (US); Michael Brojanac, Jackson, WI (US); Gary Burmesch, Port Washington, WI (US)

Correspondence Address: CALFEE, HALTER & GRISWOLD LLP, 1400 MCDONALD INVESTMENT CENTER, 800 SUPERIOR AVENUE, CLEVELAND, OH, 44114, US

(21) Appl. No.: 11/520,217

(22) Filed: Sep. 13, 2006

Related U.S. Application Data
(60) Provisional application No. 60/716,414, filed on Sep. 13, 2005.

(51) Int. Cl. E05B 37/02

(52) U.S. Cl. 70/312

(57) ABSTRACT

In one exemplary embodiment, a combination lock includes a mechanical locking mechanism, a dial, and an electronic interface. The mechanical locking mechanism includes a locking member movable between a locked condition and an unlocked condition. The dial is assembled with the locking mechanism such that successive rotation of the dial to a series of one or more predetermined rotational positions causes the locking mechanism to move the locking member from the locked condition to the unlocked condition. The electronic interface is configured to translate incremental rotational positions of the dial to corresponding electrical signals and to process the electrical signals and display corresponding incremental positional indicators.

### CROSS REFERENCE TO RELATED APPLICATION

This application claims the benefit of U.S. Provisional Patent Application No. 60/716,414, filed Sep. 13, 2005, the entire disclosure of which is hereby incorporated by reference.

### FIELD OF THE INVENTION

The present invention relates to a combination lock and more specifically to a combination dial lock with a programmable electronic interface.

### BACKGROUND

Combination locks are used in commercial, residential, and institutional environments to provide lockable access to personal items and/or enclosures. The combination lock may be a separate device, such as a combination padlock, which may be shackled to a door, bracket, cable, or other item to restrict access. Alternatively, the combination lock may be integral to an enclosure, such as a safe or a storage locker. One such exemplary application is a combination lock used to secure a school locker.

The locking mechanism of a prior art combination lock 1, as illustrated in FIG. 1, has remained relatively unchanged for many years. A numbered combination dial 2, which serves as the user interface, is positioned on an external surface of the lock 1. Rotation of the dial causes a drive cam 3 to engage a series of rotating cams or wheels 4 (usually three for a conventional combination padlock or school locker). Detents 9 extending from each of the wheels 4 engage each other to cause the wheels 4 to rotate together. By rotating the dial 2 to successive predetermined positions identified by the numbers on the dial 2 (i.e., the lock access combination), a notch or recess 6 in each of the wheels 4 is brought into alignment with a latch or fence 7 forced into a locked position by an outer periphery of the wheels 4. When all of the notches 6 are aligned with the fence 7, the fence is permitted to bias or spring into the aligned notches 6, allowing a connected locking member 5 to move out of locking engagement with a hasp, in the case of a combination padlock, or a locker doorway, in the case of a combination locker (not shown).

While the use of a combination lock, as compared to a key based lock, may eliminate the risk of lost, stolen, or copied keys, the use of combination locks in many institutional settings, such as school buildings, may present some drawbacks. Since the lock, over time, will be used by more than one person (for example, a school locker is conventionally used by a different student each school year), the access combination may need to be changed to prevent unauthorized access to the locker by a prior occupant. An authorized access combination of a conventional combination lock may be changed by offsetting the position of the dial and cam assembly with respect to the latch, such that the notches of the cams align with the latch at different numerical or incremental dial positions. A conventional combination lock typically has five available offset positions, thereby producing five different authorized combinations. The limited number of authorized combinations may present security concerns. Also, the time consuming nature of mechanically changing the combinations may be magnified in an institutional setting, such as a school, in which hundreds of locker combinations may need to be changed on a regular basis.

### SUMMARY OF THE DISCLOSURE

In accordance with one inventive aspect of the present application, a combination lock may be provided with an electronic user interface to identify a relative position of a combination dial when turning the dial to unlock the combination lock. The interface may be adapted to detect incremental movement of the dial, such as with an incremental encoder, or absolute rotational position of the dial, such as with an absolute encoder. The interface may further be programmable to alter an electronic display provided by the interface. By providing an adaptable electronic interface, access to the locked item or structure may be controlled without altering a mechanical combination lock mechanism, such as, for example, by disabling or “turning off” a visible aspect of the interface, by changing a displayed position identification associated with a relative position of the combination dial.

Accordingly, in one exemplary embodiment, a combination lock includes a mechanical locking mechanism, a dial, and an electronic interface. The mechanical locking mechanism includes a locking member movable between a locked condition and an unlocked condition. The dial is assembled with the locking mechanism such that successive rotation of the dial to a series of one or more predetermined rotational positions causes the locking mechanism to move the locking member from the locked condition to the unlocked condition. The electronic interface is configured to translate incremental rotational positions of the dial to corresponding electrical signals and to process the electrical signals and display corresponding incremental positional indicators.

### BRIEF DESCRIPTION OF THE DRAWINGS

Further features and advantages of the invention will become apparent from the following detailed description made with reference to the accompanying drawings, wherein:

FIG. 1 is a side cross sectional view of a prior art combination lock;

FIG. 2 is a perspective view of a combination lock with electronic interface;

FIG. 3 is a block diagram of a combination lock with electronic interface;

FIG. 4A is an exploded perspective view of a user interface portion of a combination lock; and

FIG. 4B is an exploded perspective view of an encoding portion of a combination lock.

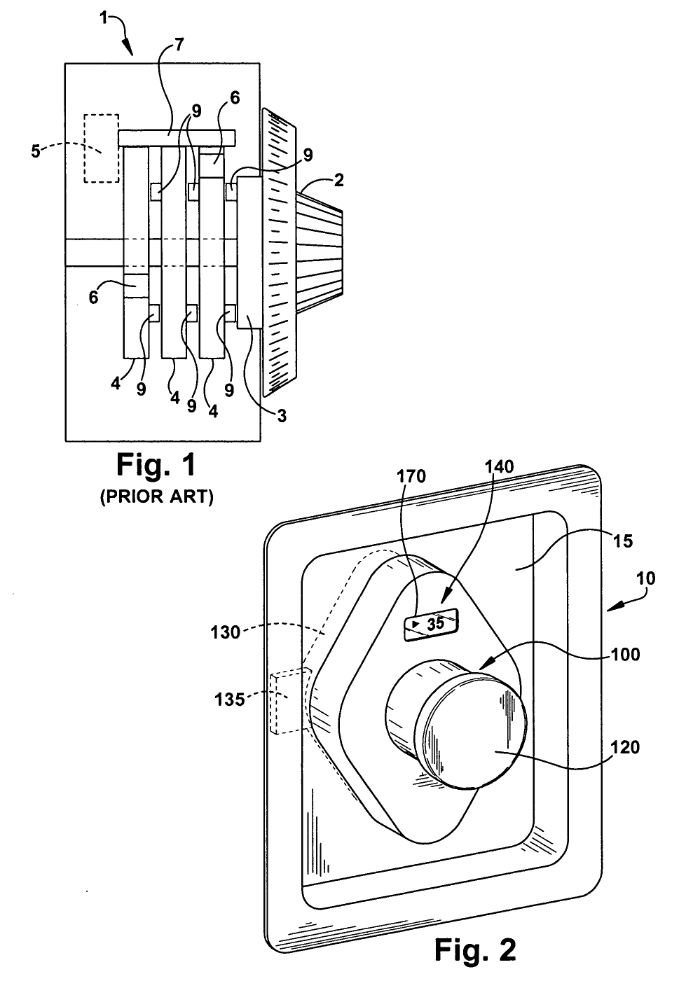

### DETAILED DESCRIPTION OF THE INVENTION

The present application relates to combination lock arrangements that may be used with many different types of locks, such as, for example, combination padlocks, safe locks, and integral locks for lockers, mailboxes, storage sheds, or other such structures and enclosures. While the embodiments described in the present application refer to a locker-type lock (such as a school locker) having a single combination dial, the inventive aspects described herein may be applied to any type of lock incorporating any number of combination dials. This Detailed Description merely describes exemplary embodiments and is not intended to limit the scope of the claims in any way. Indeed, the invention as described is broader than and unlimited by the described embodiments, and the terms used have their full ordinary meaning.

According to one aspect of the present application, a combination lock utilizing a mechanical locking mechanism, such as, for example, a conventional rotating cam or “wheel-pack” mechanism, may be provided with an electronic user interface configured to display a visual indicator corresponding to a rotational position of the combination dial. An encoder, such as, for example, an optical, magnetic, or mechanical switch encoder, may be used to translate a rotational position of the dial to one or more electrical signals that may be delivered to the interface. The interface may include a processor or microcontroller that processes the electrical signals to display a positional indicator on the interface, such as, for example, a visual display on an LCD or LED panel. While the indicator may be an incremental number, consistent with the numbers on a conventional combination lock dial, any indicator may be used to identify the rotational position of the dial, such as, for example, other visual indicators, such as letters, symbols, colors, and varying sizes or quantities of “dots” or other icons, audible indicators, such as beeps or spoken numerical positions, or tactile indicators, such as raised bumps or other protrusions caused to extend from a panel. In one such embodiment, the combination dial may be free of markings, such as the numbers or incremental hash marks used on conventional combination lock dials, such that a user must rely on the indicators provided by the interface to determine the rotational position of the dial.

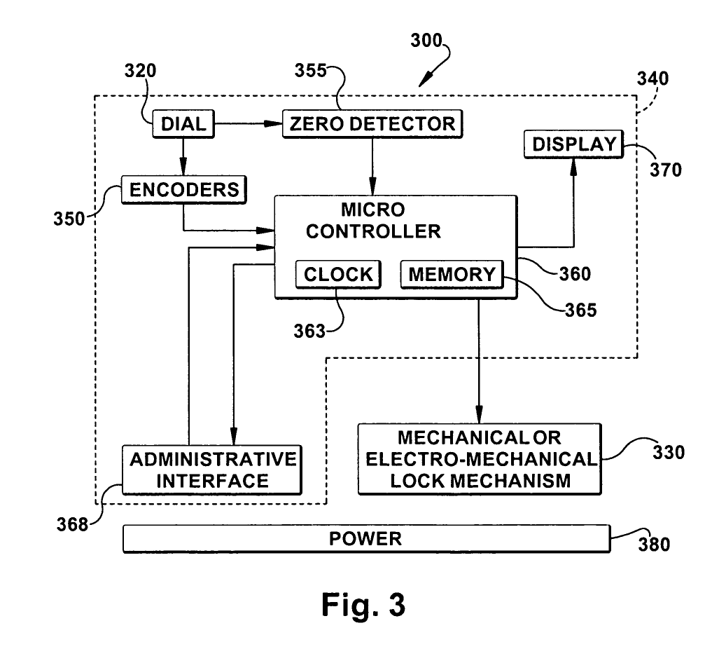

Referring now to the drawings, FIG. 2 shows a general schematic view of a locker 10 with a built-in combination lock 100. The exemplary lock 100 includes a dial 120, a locking mechanism portion 130 in communication with the dial 120, and an electronic interface portion 140, also in communication with the dial 120, which may include an electronic display 170, such as, for example, an LCD panel, to visually indicate the rotational position of the dial 120, as discussed in greater detail below. The locking mechanism portion 130 is movable from a locked condition, in which the locker door 15 is held closed by a locking member 135, and an unlocked condition, in which the locker door 15 is permitted to open. The locking mechanism 130 may include many different types of locking mechanisms operable by the successive rotation of the dial to a series of one or more predetermined rotational positions. The locking mechanism 130 may include a mechanical locking mechanism, such as, for example, the stacked cam or “wheel pack” arrangement used with conventional combination locks and described above. Alternatively, the locking mechanism may include an electro-mechanical mechanism, such as, for example, an arrangement in which dialing an authorized combination causes an electrical signal to be sent to a microcontroller, which causes a motorized locking mechanism to unlock the lock. Many different electro-mechanical mechanisms may be incorporated into a combination lock. Examples of electro-mechanical locking mechanisms associated with electrically operated padlocks are described in U.S. application Ser. No. 11/443,828, filed on May 31, 2006 and entitled “Electronic Security Device,” the entire disclosure of which is incorporated herein by reference. By using an electro-mechanical locking mechanism instead of the conventional mechanical locking mechanism, many different combination dialing options may be provided for entry of the authorized combination, including, for example, turning the dial in a single direction, incorporating a push-button entry of a dialed rotational position, or the use of a toggle-type dial that may be held in a pivoted position to incrementally change a combination code entry (instead of fully rotating the dial).

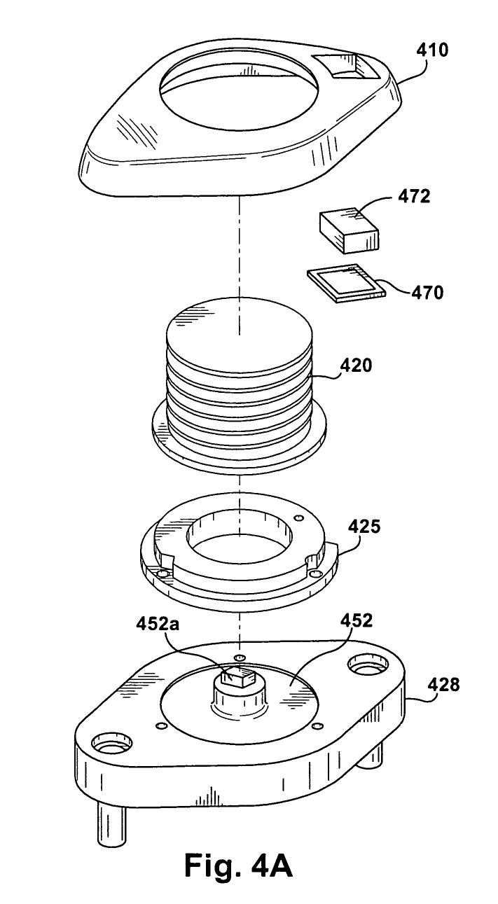

As shown in the block diagram of FIG. 3, a dial 320 may be connected with, or in communication with, an electronic interface 340 through the use of an encoder 350, which translates the rotational position and/or movement of the dial 320 into a corresponding electrical signal. The signal is processed by a processor or microcontroller 360 which causes the electronic interface 340 to communicate a position indicator on a display 370. Many different types of displays may be used to indicate the dialed position, such as, for example, LCD or LED display panels. This display 370 may be located in many different positions on or separate from the lock, including, for example, on the dial, on the lock housing, on the locker door, or on a surface or panel separate from the locker.

As indicated above, many different types of visual indicators may be displayed by the interface 340. Some examples of possible visual position indicators are listed below in Table I:

TABLE I
Position Indicator Options

| 1. Standard | 2. Zero | 3. Random | | 5. Increased |
|---|---|---|---|---|
| Increment | Offset | Increment | 4. Alphabet | Resolution |
| 0 | 35 | 21 | A | 0 |
| | | | | 1 |
| 1 | 36 | 4 | B | 2 |
| | | | | 3 |
| 2 | 37 | 17 | C | 4 |
| | | | | 5 |
| 3 | 38 | 13 | D | 6 |
| | | | | 7 |
| 4 | 39 | 33 | E | 8 |
| | | | | 9 |
| 5 | 0 | 9 | F | 10 |
| | | | | 11 |
| 6 | 1 | 5 | G | 12 |
| | | | | 13 |
| 7 | 2 | 22 | H | 14 |
| | | | | 15 |
| 8 | 3 | 15 | I | 16 |
| | | | | 17 |
| 9 | 4 | 30 | J | 18 |
| | | | | 19 |
| 10 | 5 | 3 | K | 20 |

In one exemplary embodiment, as partially shown in column 1 of Table I, a set of incremental indicators (for example, numbers ranging from zero (0) to thirty-nine (39)) may be selectively provided to identify incremental rotational positions of the dial 320. As such, the dial may be provided with a visually indicated zero position corresponding with a set of rotational position, at which the incrementally increasing (or decreasing) numerical display is reset. This numbering may be consistent with the numbered dial markings of a conventional combination lock, with the zero position corresponding with the zero position of a mechanical locking mechanism, as identified by a zero detector 355, such as, for example, an encoder, within the electronic interface 340. As another example, as partially shown in column 2, the same numbering may be used with the zero position offset from the zero position of the mechanical locking mechanism. In another example, as partially shown in column 3, the incremental numbers may be rearranged in virtually any order to provide a greater number of possible visual position indicator combinations corresponding with the successive rotational positions for unlocking the combination lock 300. In other examples, positional units may include other characters or symbols, such as, for example, letters (as shown in column 4 of Table I) or symbols, such as pictures or shapes. In still another example, as partially shown in column 5, the resolution of the position indicators may be changed, thereby changing the number of increments in a full rotation of the dial, such as, for example, from 40 increments to 80 increments.

According to another aspect of the present application, additional information may be provided by an electronic interface. Examples of such information include, for example, identification of the number of times or the most recent time the lock or locker has been accessed, identification of an incorrect or failed attempts to open the lock, a count of the current rotations of the dial (especially for lock mechanisms that require multiple rotations of the dial, for example, to align stacked cams), or identification of previous rotational positions (such as positions where direction of rotation changed; e.g. identification of most recent position, two most recent positions, etc.) during operation of the combination dial.

According to the present application, an exemplary electronic interface 340 of a lock may provide other outputs that are not directly perceptible on the electronic interface. The lock may provide electronic data signals, such as through wireless communication (such as radio frequency or infrared communication) or a wired connection (such as a serial or USB port) to which a monitoring device (such as a PDA) may be connected (not shown). Through this output, the lock 300 may provide information, such as the times or frequency at which the lock was accessed, or the identification of unsuccessful attempts to unlock the lock.

In addition to the data signal and position indicating outputs of the electronic interface, the lock may be adapted to receive data signal inputs by a user or administrator of the lock. The data input capability may be provided by the same electronic interface that provides the position indicator, or the input capability may be provided by a different interface mechanism or assembly. Many different mechanisms may be used to provide data signal input to the electronic interface 340 of the lock 300, such as, for example, a mechanical key override, dial or push-button entry (which may be limited to instances when the lock has been opened), infrared (IR) communication, and radio frequency (RF) communication (not shown). Current technologies for infrared communication (such as Infrared Data Association, or IrDA, standards) or RF communication (such as Bluetooth® or Zigbee®, an IEEE 802.15 transmission medium) may provide for secure remote wireless access to communicate with the lock's electronic interface.

Many different types of instructions may be communicated to the electronic lock 300, including for example; information for storage on and/or display by the lock, or instruction to disable or alter the operation of the lock. The microcontroller 360 may be provided with sufficient memory 365 to store this information. The electronic interface 340 may be configured to receive input signals, such as through an administrative interface 368 for controlling a position indicator displayed by the electronic interface 340, for example, to control access to the lock 300. In one embodiment, the position indicators may be disabled or “turned off” to temporarily prevent the lock 300 from being unlocked, without having to physically disable the locking mechanism. In other embodiments, an input signal may be used to change a standard numerically incremented dial position, for example, ranging from 0-39, to a new range of incremental position indicators, such as those shown in Table I above, while leaving the actual rotational positions of the authorized dialing combination unchanged, thereby resulting in different visual position indicators corresponding with the authorized successive rotational positions of the lock dial. By allowing for the above alterations, a combination lock with a mechanical locking mechanism, such as a stacked cam or wheel-pack mechanism, may be adaptable to accept one of hundreds of different authorized combinations without modifying the mechanical locking mechanism. If the mechanical locking mechanism is also modified (such as by changing between any of the five lock settings typical of a conventional combination locker), even more authorized combinations may be available.

Even more lock access options may be available if an electronic interface 340 as described in this application is provided with a combination lock having an electro-mechanical locking mechanism 330. In addition to the above example alterations, an input signal to the electronic interface 340 of an electro-mechanical combination lock may, for example: alter the rotational dial positions required to unlock the lock (as opposed to the numerical position indicators associated with the rotational positions); alter the number and/or direction of successive rotations necessary to unlock the lock; provide for quick (e.g., single input) administrator or “master” access to the lock; or provide for electronic disabling of the locking mechanism itself.

According to another aspect of the present application, the lock may include a real time clock 363 in communication with the microcontroller 360. The clock 363 would allow a user or administrator to control access to the lock during certain time periods. For example, in an institutional setting, such as with school lockers, access to a locker may be altered during summer vacation, weekends and holidays, after school hours, or periods of locker use by different students or other users. These time-related functions may be controlled by software or firmware internal to the lock and in communication with the clock 363, or by programming the lock 300 through the input of data signals to the electronic interface 340, as described above.

The lock 300 may be provided with an internal power supply 380 such as, for example, a battery or an embedded power generator, such as a solar power cell. The lock 300 may alternatively or additionally be powered by an external power supply, particularly in applications where the lock will not be transported, such as with a school locker. To preserve power, the lock's microcontroller 360 may include a wake-up switch that signals the microcontroller and other electronics to initiate out of a sleep mode when an event occurs, such as for example, when the dial 320 is rotated.

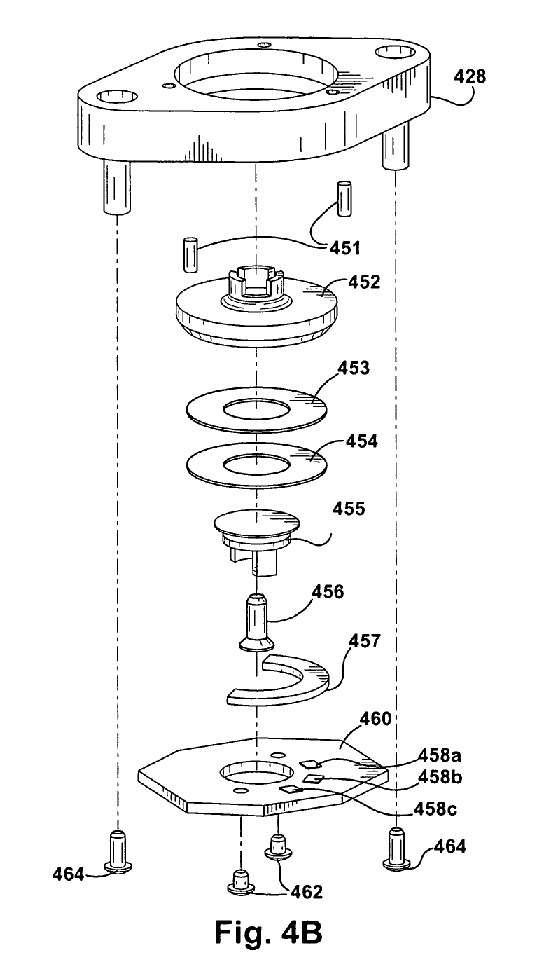

FIGS. 4A and 4B illustrate an exemplary embodiment of a combination lock for a locker, according to the present application. FIG. 4A is an exploded view of an external user interface portion of the lock 400. An escutcheon plate 410 is fastened to a base plate 428 to retain a dial 420 and to provide a desired aesthetic appearance for the lock 400. The escutcheon plate 410 is provided with a window to display the LCD panel 470, which may be protected by a lens 472, such as a clear plastic lens. The LCD panel 470 may be connected to the microcontroller by a cable extending through an opening in the base plate (not shown). The dial 420 may be affixed to a encoder mounting disk 452 by a mounting ring 425 adapted to fit underneath the dial 420, and fastened to the escutcheon plate 410, such as with rivets. The mounting ring 425 is configured to allow the dial to rotate, and a hole (not shown) in the base of the dial 420 receives a complementary shaped shaft 452a extending from the encoder mounting disk 452, causing the disk 452 to rotate with the dial 420. Additionally, the mounting ring 425 may optionally include a spring loaded member, such as a ball, that biases against the underside of the dial 420 to provide a tactile detent or “click” feel as the dial is rotated.

Referring now to an encoder portion of the combination lock (350 in FIG. 3), as shown in FIG. 4B, a microcontroller for the electronic interface of the lock includes a printed circuit board 460, which is fastened to the base plate 428 by mounting screws 464, and may be more precisely positioned within the lock by mounting pins 451. Stacked between the exemplary encoder mounting disk 452 and the circuit board 460 are a reflective disc 453 and an encoder disk 454 fixed to the encoder mounting disk 452 by a pronged lock interface disk 455 and a mounting screw 456. The pronged end of the lock interface disk 455 is configured to operate a mechanical locking mechanism (not shown) in the lock, such as a conventional stacked cam or wheel pack configuration. An aperture plate 457 is affixed to the circuit board 460 to cover optical encoders 458a, 458b, 458c, also attached to the circuit board 460. Small apertures in the aperture plate 457 align with the encoders to allow light to be transmitted by one or more of the encoders through the encoder disk 454 to be reflected by the reflective disk 453 back to the encoders, to be received by one or more of the encoders 458a 458b, 458c. Each of the encoders may transmit light and/or receive light.

The clear encoder disk 454 includes a number of radially positioned markings or bars (not shown), corresponding to incremental rotational movement of the dial 420, which block the transmission of light to or from the encoders when one of the bars is aligned with the corresponding aperture in the aperture plate. By counting the number of times that light is alternately blocked by and transmitted through the encoder disk 454 during rotation of the dial 420, the microcontroller can identify the incremental rotation of the dial and translate the electronic signal to a position indicator corresponding to the resulting rotational position. Different incremental resolutions may be provided for by using encoder disks with different numbers of radial bars. In one example, for a lock having 50 incremental rotational positions, an encoder disk with 50 bars may be used. Additionally, one of the optical encoders 458a, 458b, 458c may function as a zero detector to identify a mechanical zero position for the mechanical locking mechanism, to provide a point of reference for all other rotational positions of the dial. Further, one of the optical encoders 458a, 458b, 458c may be used to signal the microcontroller to wake from a sleep mode after a period of non-use, for example, to conserve power. In one example, an optical encoder may be configured to “wake up” the microcontroller when the dial has been rotated not more than 180°. As indicated above, other types of encoder arrangements may be used, such as, for example, absolute encoders. Also, other types of incremental encoders may be used, such as, for example, magnetic or mechanical switch encoders.

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, circuits, devices and components, software, hardware, control logic, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative indicators and ranges may be included to assist in understanding the present disclosure; however, such indicators and ranges are not to be construed in a limiting sense and are intended to be critical indicators or ranges only if so expressly stated. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention, the inventions instead being set forth in the appended claims. Descriptions of exemplary methods or processes are not limited to inclusion of all steps as being required in all cases, nor is the order that the steps are presented to be construed as required or necessary unless expressly so stated.

What is claimed is:

1. A combination lock comprising:
a mechanical locking mechanism comprising a locking member movable between a locked condition and an unlocked condition;
a dial, wherein successive rotation of the dial to a series of one or more predetermined rotational positions causes the locking mechanism to move the locking member from the locked condition to the unlocked condition; and
an electronic interface, configured to translate incremental rotational positions of the dial to corresponding electrical signals and to process the electrical signal and display incremental positional indicators corresponding to the incremental rotational positions of the dial.

2. The combination lock of claim 1, wherein the incremental positional indicators comprise numerical indicators.

3. The combination lock of claim 1, wherein the incremental positional indicators comprise alphabetical indicators.

4. The combination lock of claim 1, wherein the incremental positional indicators comprise symbolic indicators.

5. The combination lock of claim 1, wherein the electronic interface is configured to reset the incremental positional indicators when the dial is rotated to a predetermined zero position.

6. The combination lock of claim 5, wherein the electronic interface is configured to selectively adjust the predetermined zero position.

7. The combination lock of claim 1, wherein the electronic interface is configured to selectively adjust the incremental positional indicators corresponding to incremental rotational positions of the dial.

8. The combination lock of claim 1, wherein the electronic interface is configured to selectively adjust a resolution of the incremental positional indicators.

9. The combination lock of claim 1, wherein the electronic interface is configured to selectively prevent display of the incremental positional indicators to disable the lock.

10. The combination lock of claim 1, wherein the electronic interface comprises an encoder configured to translate a rotational position of the dial to a corresponding electrical signal.

11. The combination lock of claim 10, wherein the encoder measures incremental movement of the dial.

12. The combination lock of claim 10, wherein the encoder measures an absolute position of the dial.

13. The combination lock of claim 1, wherein the electronic interface comprises an LCD display.

14. The combination lock of claim 1, wherein the electronic interface is adapted to provide one or more output signals corresponding to one or more conditions of the lock.

15. The combination lock of claim 14, wherein the one or more conditions of the lock comprise at least one of: user identification, lock identification, lock usage history, rotational positions during current operation of the dial.

16. The combination lock of claim 1, wherein the electronic interface is adapted to receive one or more input signals and to display a corresponding message in response to the one or more input signals.

17. The combination lock of claim 1, wherein the electronic interface is adapted to receive one or more input signals and to alter the incremental positional indicators in response to the one or more input signals.

18. The combination lock of claim 1, wherein the electronic interface is adapted to provide one or more output signals by at least one of: radio-frequency communication, USB connectivity, and infrared communication.

19. The combination lock of claim 1, wherein the electronic interface is adapted to receive one or more output signals by at least one of: radio-frequency communication, USB connectivity, and infrared communication.

20. The combination lock of claim 1, wherein the locking mechanism comprises one or more cams, wherein movement of each of the one or more cams to a corresponding unlocking position causes the locking member to move from the locked condition to the unlocked condition.

21. A method of controlling access to a combination lock including a locking member movable between a locked condition and an unlocked condition, and a dial, wherein successive rotation of the dial to a series of one or more predetermined rotational positions moves the locking member to the unlocked condition, the method comprising:
translating incremental rotational positions of the dial to corresponding electrical signals;
processing the electrical signals to display incremental positional indicators corresponding to the incremental rotational positions; and
selectively adjusting the incremental positional indicators associated with the corresponding incremental rotational positions to modify an authorized combination of the combination lock.

22. The method of claim 21, wherein selectively adjusting the incremental positional indicators comprises selectively adjusting a rate of incrementation of the incremental positional indicators.

23. The method of claim 21, wherein selectively adjusting the incremental positional indicators comprises selectively adjusting a zero position associated with one of the incremental rotational positions of the dial.

24. A method of controlling access to a combination lock including a locking member movable between a locked condition and an unlocked condition, and a dial, wherein successive rotation of the dial to a series of one or more predetermined rotational positions moves the locking member to the unlocked condition, the method comprising:
translating incremental rotational positions of the dial to corresponding electrical signals;
processing the electrical signals to display incremental positional indicators corresponding to the incremental rotational positions; and
selectively disabling the display of the incremental positional indicators to prohibit rotation of the dial to the series of one or more predetermined rotational positions.
